(19) United States
(12) Patent Application Publication
(10) Pub. No.: US 2023/0011058 A1
(43) Pub. Date: Jan. 12, 2023

(54) Multi-Section Protective Garment

(71) Applicant: Barbara Squires, Phoenix, AZ (US)

(72) Inventor: Barbara Squires, Phoenix, AZ (US)

(21) Appl. No.: 17/369,064

(22) Filed: Jul. 7, 2021

(51) Int. Cl. A41D 13/11; A62B 23/02; A41D 27/20; A41D 23/00

(52) U.S. Cl. CPC A41D 13/1107; A62B 23/02; A41D 27/201; A41D 23/00

(57) ABSTRACT

A protective garment, such as a scarf, is provided having a first section and a second section that are detachable from one another. The first section, when detached, forms a fabric tube that may be worn over a user's nose and mouth as a gaiter or religious face and head covering for providing air filtration, while the second section continues to be worn as a garment. The first and second sections may then be reattached to again form a continuous garment. The first section may include an air filter pocket for insertion of a removable air filter to provide increased filtration. The second section may include accessory pockets.

### CROSS-REFERENCES TO RELATED APPLICATIONS

None

### TECHNICAL FIELD

The present disclosure relates to a wearable protective garment. More specifically, the present specification discloses a piece of wearable protective garment with multiple sections, which can be worn individually or in combination.

### BACKGROUND OF THE DISCLOSURE

One of many pathways for environmental pollutants to enter our body is through breathing and/or ingestion. Air pollutants range from gaseous toxins, smaller airborne bacteria and viruses, to larger particulate matter (PM10 and PM2.5), which may include solid or liquid droplets or particles containing dust, pollen or mold spores. Detrimental health effects are linked to long-term as well as to short-term exposure to air pollutants. People have long adapted existing wrap garments, such as scarf or shawl, fabric or knit headwear, hijab or burka etc., to simply cover ones nose and mouth. There is, however, an increased urgency to use more sophisticated and targeted air filters to prevent inhalation and/or ingestion of environmental pollutant resulting directly from centuries of industrialization and concentration of biological population. The present disclosure is directed to a wearable garment with attachable/detachable sections, which can then be worn individually or in combination. Sections may further be adapted to accommodate modern air filters, so as to make them light and portable, replaceable, and easier to use.

### BRIEF SUMMARY OF EMBODIMENTS OF THE DISCLOSURE

The present disclosure relates to a wearable protective garment having a first section that may be removably detached from a second section for use as an air filtration accessory.

In some embodiments, the protective garment may be a scarf or a hijab. A first section with a first connection edge may be removably attached to a corresponding second connection edge of a second section. The first section is formed from fabric, tubular in shape, and collapsible to a flat form. The second section is also formed from fabric, with a length greater than the first section. The fabric from which the first and second sections are formed may be the same, or different. The garment may be utilized in a first configuration, in which the first section is detached from the second section and pulled around a user's head for wearing as a gaiter, or over the head as a head cover, while the second section may be wrapped around some portion of the user's body. The garment may also be used in a second configuration, in which the first section and the second section are attached by joining the first connection edge and the second connection edge, and worn around the user's body as a single garment. In a variant in which the protective garment is a scarf, the second section may be worn as a scarf regardless of whether the first section is attached or detached.

Various pockets may be provided in the garment to improve functionality. The first section may include, for example, a pocket configured to receive a removable air filter. The pocket will generally be positioned to rest in front of a user's nose and/or mouth when the first section is worn in the first configuration. Additionally or alternatively, one or more accessory pockets may be provided in the second section. The accessory pocket(s) may be used, for example, to store sanitary gloves, hand sanitizer, wipes, extra filters, or even the first section when not in use. The pockets may be optionally secured by closure mechanisms such as zippers, hook-and-loop fasteners, hook-and-fabric fasteners, snaps or buttons.

The first section may include a cord with cord lock passing around the circumference of the first section. The cord may be drawn in after the first section is placed onto a user's head, thereby helping secure the first section in place on a user's head.

Various mechanisms may be employed to attach and detach the first section and the second section. In some embodiments, a hook-and-fabric or hook-and-loop attachment mechanism may be used. In particular, segments of hook material may be spaced around a connection edge of the first or second section, such that the elasticity of fabric material between the segments permits ready expansion and contraction of the garment material. In other embodiments, a zipper may be used.

Other features and aspects of the disclosure will become apparent from the following detailed description, taken in conjunction with the accompanying drawings, which illustrate, by way of example, the features in accordance with embodiments of the disclosure. The summary is not intended to limit the scope of the disclosure, which is defined solely by the claims attached hereto.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure. It should be noted that for clarity and ease of illustration these drawings are not necessarily made to scale.

Some of the figures included herein illustrate various embodiments of the disclosure from different viewing angles. Although the accompanying descriptive text may refer to such views as “top,” “bottom” or “side” views, such references are merely descriptive and do not imply or require that the disclosure be implemented or used in a particular spatial orientation unless explicitly stated otherwise.

FIG. 1 illustrates an exemplary scarf having a first and a second section connected to form a unitary garment.

FIG. 2 illustrates the first and the second section separated into two individual pieces.

FIG. 3 illustrates the first section in greater detail.

FIG. 4 illustrates an exemplary insert pocket along the inside surface of the first section.

FIG. 5 illustrates two sections worn separately, but in combination.

FIG. 6 illustrates the second section in greater detail.

FIG. 7A illustrates a schematic front view of the garment with sections connected.

FIG. 7B illustrates a schematic inside view of the garment with sections connected.

FIG. 8 illustrates an enlarged view of an end region in the first section where a filter may by inserted for further protection.

FIG. 9 illustrates an enlarged view of an end region in the second section having pockets.

The figures are not intended to be exhaustive or to limit the disclosure to the precise form disclosed. It should be understood that the disclosure can be practiced with modification and alteration, and that the disclosure be limited only by claims and the equivalents thereof.

### DETAILED DESCRIPTION OF THE EMBODIMENTS OF THE DISCLOSURE

From time-to-time, the present disclosure is described herein in terms of example environments. Description in terms of these environments is provided to allow the various features and embodiments of the disclosure to be portrayed in the context of an exemplary application. After reading this description, it will become apparent to one of ordinary skill in the art how the disclosure can be implemented in different and alternative environments.

Unless defined otherwise, all technical and scientific terms used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

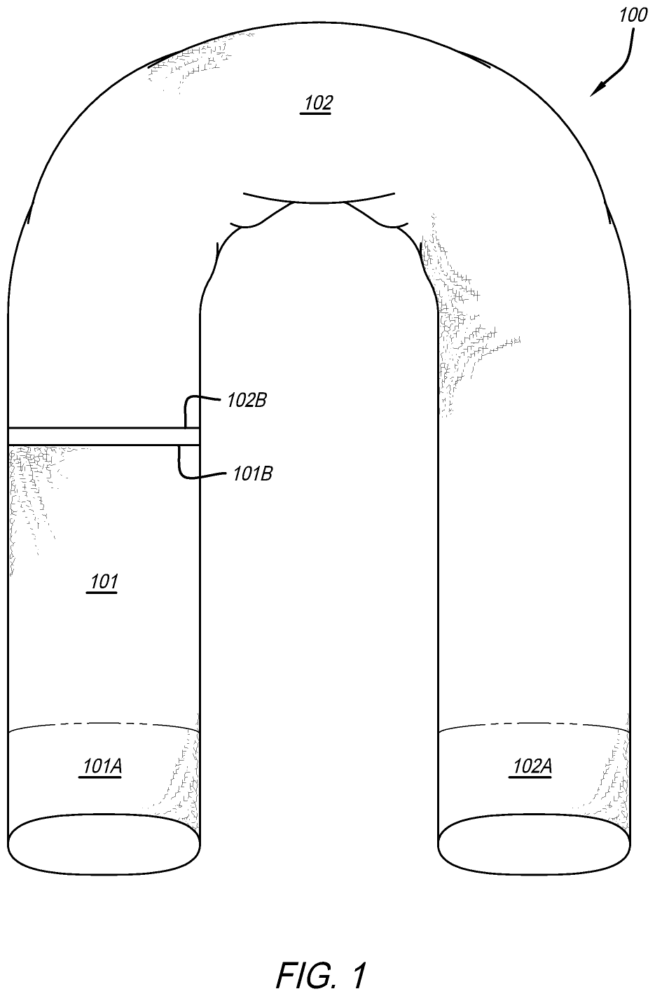

For simplicity of illustration, FIGS. 1-9 refer to a scarf or to a rectangular piece of fabric intended to be wrapped around a user, with a two-piece design. Such a concept can be readily adapted to a variety of wearable garments, which are not limited to rectangular in shape and form. Exemplary variations will be discussed in a later section of the present disclosure.

FIG. 1 illustrates a scarf 100 having two sections 101 and 102, connected along edges 101B and 102B. In the illustrated embodiment, scarf 100 forms an elongated form that is generally rectangular in cross-section or as viewed from above. In accordance with a conventional mode of use, scarf 100 may be worn or used as one long piece, wrapped around e.g. a user's neck for warmth and/or for cosmetic purposes. Scarf 100 further comprises an end region 101A and 102A respectively for each of sections 101 and 102, which are described further below.

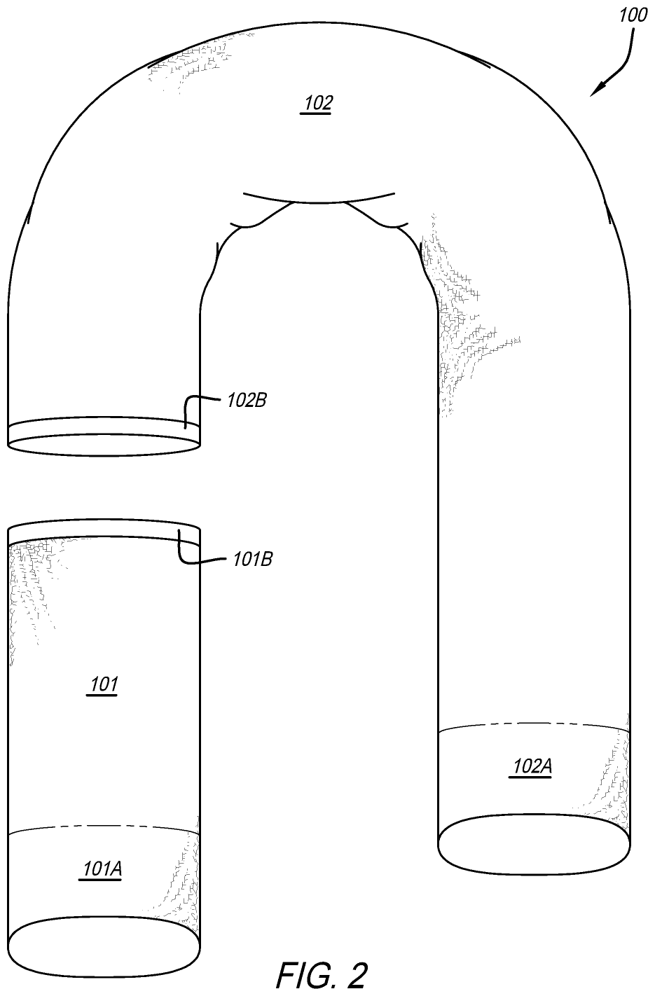

FIG. 2 illustrates scarf 100 with sections 101 and 102 in a second configuration, separated along edges 101B and 102B, which effectively makes section 101 and 102 into two individual pieces which may be worn in different manners, whether together or separately.

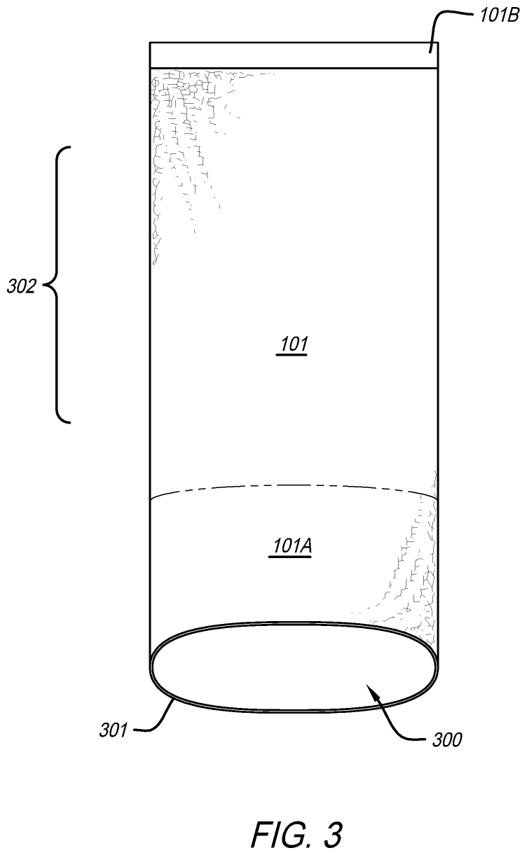

FIG. 3 is an enlarged view of section 101, with its edge 101B and end region 101A. Section 101 is tubular in shape, having a central cavity 300 that is circumscribed by fabric loop 301 and open at end 101A and edge 101B. Thus, when separated from section 102, section 101 may form a gaiter that can be worn by pulling over a user's head (i.e. such that the user's head passes through end region 101B, and into central cavity 300). When worn as a gaiter, region 101B typically then wraps around a user's neck, with a central portion 302 of fabric loop 301 wrapping around the user's face and covering a user's nose and mouth. In this manner, scarf 100 may be worn as a fashion or insulative scarf accessory when high levels of air filtration are not required. When air filtration is required, section 101 may be readily separated from section 102 and worn as a gaiter-style air filtration mask. When such enhanced masking or air filtration is no longer required, section 101 may be re-attached to section 102 by matching edge 101B with edge 102B.

Section 101 is preferably formed from a non-rigid fabric material having some degree of elasticity, such that it may be stretched around a user's head for use as a gaiter, and subsequently collapsed to a flat rectangular form when not in use as a gaiter. In some embodiments, when section 101 is collapsed, it will have a width that is similar to, or the same as, that of section 102, such that the first and second sections together appear as a single, continuous garment upon casual viewing. Typically, section 102 will have a length and/or surface area that is greater than that of section 101, such that section 101 forms a main or primary portion of the overall garment (i.e. scarf 100) that is usable with or without section 102, while section 102 forms a detachable sub-portion of the garment.

In some embodiments, section 102 may be formed from the same type of fabric material as section 101. Such embodiments may improve the extent to which the sections appear to be a single continuous garment when used in the attached configuration. In other embodiments, section 102 may be formed from a different material than section 101. For example, because section 101 is intended for frequent wearing over a user's face, section 101 may by formed from a material that holds up well to repeated washing, and/or includes antimicrobial characteristics; whereas section 102 may be formed from a material selected for its softness, warmth, hand feel, dye holding ability, or other aesthetic qualities.

As illustrated in FIG. 1, like section 101, section 102 is also tubular in shape. Use of a tubular section 102 may be desirable in some embodiments for, e.g., ease of manufacturing sections 101 and 102 from a continuous length of uniform material. A tubular section 102 may also provide an open end proximate portion 102A, whereby a wearer may e.g. insert one's hands into section 102, or insert one's arm into section 102, for added warmth. To the extent section 102 is formed from a pliable material such as typical garment fabrics, section 102 may collapse down to a multi-layer flat fabric structure when worn as a wrap or scarf. Thus, the tubular embodiment of section 102 as illustrated in FIG. 1 may provide various practical and functional advantages. However, it is contemplated and understood that in other embodiments, section 102 may be formed in other manners, including from a flat piece of fabric.

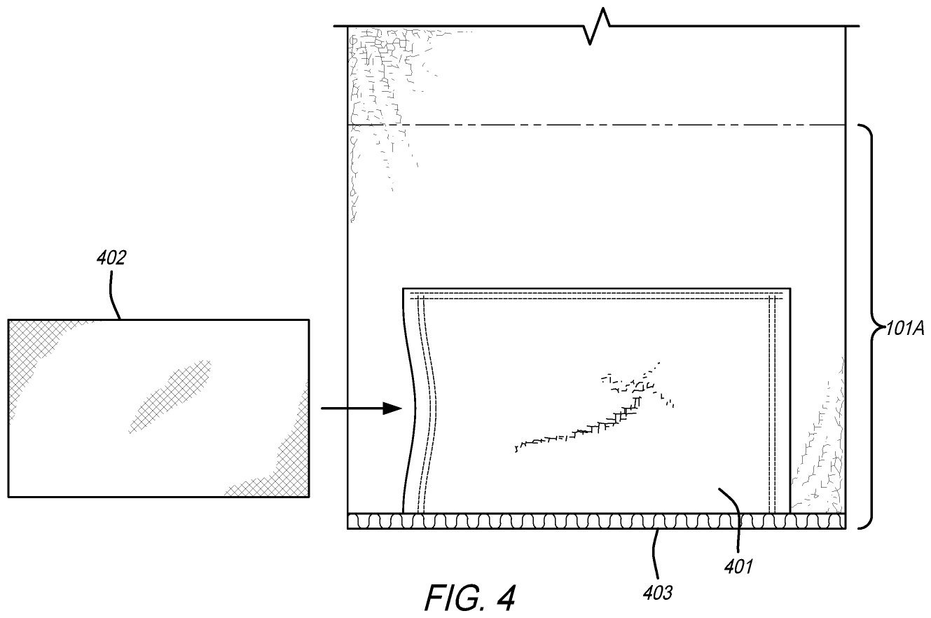

FIG. 4 illustrates a further enlarged view of end region 101A of section 101, with a filter pocket 401. Filter pocket 401 permits insertion and removal of a removable air filter 402. When section 101 is worn as a gaiter, filter pocket 401 and an inserted air filter 402 may be positioned over the user's nose and/or mouth, such that air is inhaled through filter 402 to provide additional air filtration. The remainder of section 101 further covers the user's face and neck region, and acts to hold air filter 402 in place over the user's nose and/or mouth. In some embodiments, filter pocket 401 may be rectangular in shape, 5.5 inches in width (i.e. 5.5 inches in a direction parallel with edge 101B), and 3.5 inches in height, centered on a front side of section 101 and offset slightly (e.g. 0.5 to 1.0 inches) from edge 403; such a filter pocket 401 may readily accommodate insertion and removable of common replaceable paper filters used in face masks, which may be roughly 4.75 by 3.15 inches in some embodiments.

A user may select an air filter 402 based upon their preferences and requirements. For example, air filter 402 may be selected with varying filtration capabilities (e.g. optimized for pollens, or filtering of particular particle sizes). In various embodiments, air filter 402 may also be disposable for convenience, or washable and reusable. In some circumstances, a user may have a selection of air filters 402 which may be selected based on the environmental or biological conditions to which the user expects to be exposed.

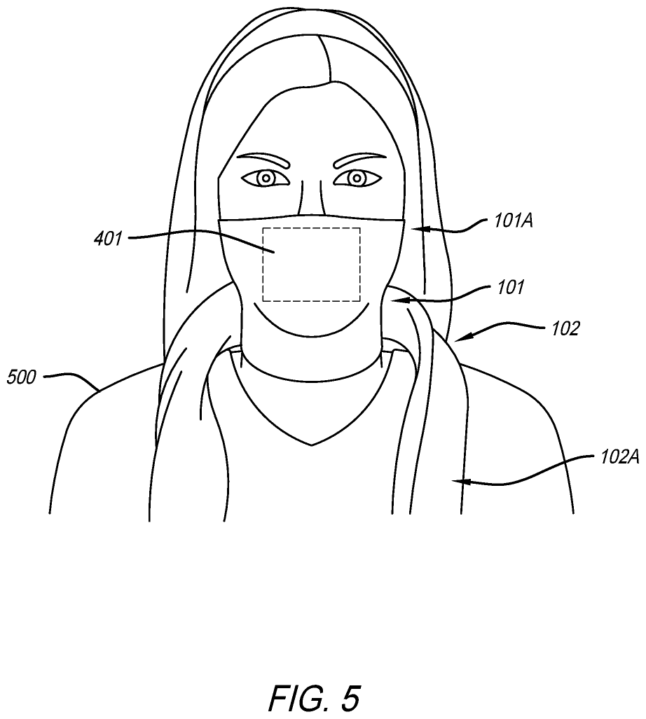

FIG. 5 is a front view of a user 500 wearing section 101 as a gaiter, detached from section 102. User 500 also wears section 102 as a scarf or shawl, over the shoulder region of user 500. End region 102A hangs down in front of user 500, providing easy access to materials stored within integrated pockets, as described below.

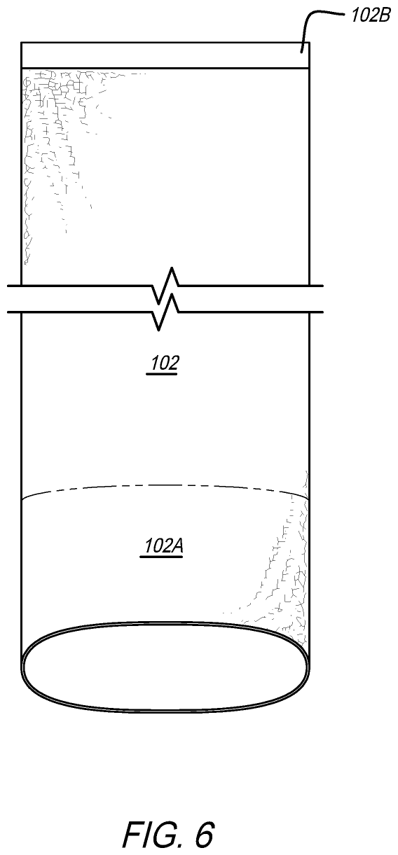

FIG. 6 is an enlarged view of section 102, separated from section 101, illustrating edge 102B and an end region 102A. The length of section 102 is not drawn in scale, and may have a length and width typical of a scarf. For example, in some embodiments, section 102 may be approximately 60 inches in length; in other embodiments, the length of section 102 may range from 50 inches to 80 inches. In some embodiments, section 102 may be approximately 8 inches wide when collapsed flat; in other embodiments, the width of section 102 may range from 6 inches to 10 inches. Preferably, the width of section 102 will be selected such that section 101 may be the same width, while effectively serving as a gaiter. Other sizes and proportions may be utilized.

In some embodiments, end region 102A may be fitted with one or more pockets, in which a user may store additional items such as gloves, hand sanitizer, keys, additional filters 402, or even section 101 after it is detached from section 102 (e.g. as an alternative to re-attaching section 101 to section 102).

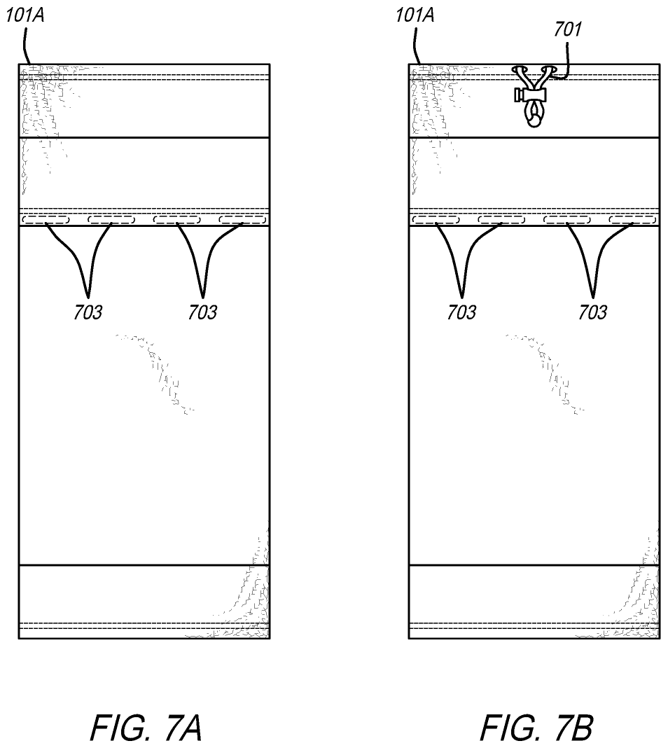

FIGS. 7A and 7B illustrate schematic views of scarf 100 with section 101 and 102 attached. FIG. 7A provides a front view. FIG. 7B provides a inside view, i.e. with the scarf of FIG. 7A having been turned inside out to illustrate internally-facing structures. In the embodiment of FIG. 7B, an exemplary cord and cord lock mechanism 701 is shown on the inside surface of end region 101A along its edge. A user can further tighten and secure the cord using the cord lock to prevent slippage and control the position of section 101 when worn as shown in FIG. 5 over his or her face. A plurality of attachment segments 703 are present along edges 101B and 102B, to serve as a connection mechanism between sections 101 and 102. In some embodiments, segments 703 may be formed from hook and loop material (such as Velcro brand hook and loop fastener), with the hook and loop portions each fixed on one of sections 101 and 102. Alternatively and preferably, hook material can be employed alone on one of edges 101B and 102B (again preferably in segments), to connect directly with fabric from which the opposing section is made (commonly referred to as a “hook and fabric” connection mechanism). By utilizing hook and fabric, a user need not align sections 101 and 102 with much effort or precision to connect them with one another, thereby facilitating rapid and easy connection. Hook material segments 703 are also preferably spaced apart from one another, so as to allow room for portions of the fabric of which section 101 is formed between segments 703, to stretch while being pulled to fit over a user's head. Preferably, sections 101 and 102 are formed from fabric having at least some amount of elasticity, to facilitate secure fit of section 101 over a user's face when worn as a gaiter.

In other embodiments, different connection mechanisms along edges 101B and 102B can be employed. For example, a zipper may be provided between sections 101 and 102. Because typical zippers are largely or entirely inelastic, in such embodiments, it may be desirable for the diameter of section 101 when separated for use as a gaiter to be sufficiently large to fit a wide spectrum of user head sizes; and as such, a mechanism such as a cinching mechanism may be desirable to keep section 101 in place on a user's head once worn. Whether to choose one connection mechanism or another depends on a balance among fabric choices, personal preferences, as well as functionalities.

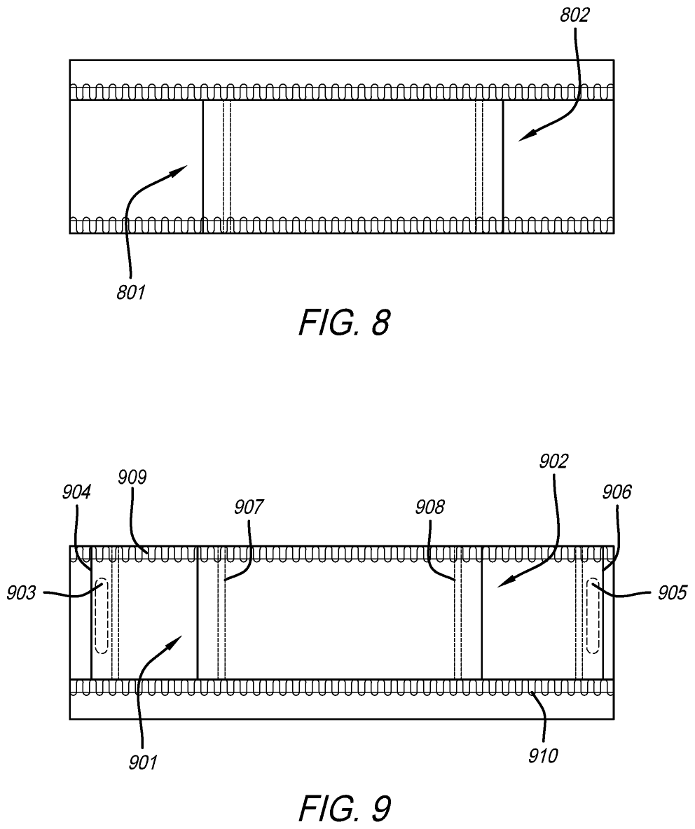

FIG. 8 provides an enlarged view of end region 101A. Slits 801 and 802 mark opening locations where filter 402 may be inserted into pocket 401.

FIG. 9 is an enlarged view of end region of section 102, in an embodiment featuring two accessory pockets 901 and 902 in which a user can store additional items into end region 102A. Closure 903 can be used to secure opening 904 of pocket 901, while closure 905 can be used to secure opening 906 of pocket 902. Closures 903 and 905 may be formed using a variety of closure mechanisms, such as hook-and-loop fastener, hook-and-fabric fastener, zippers, snaps or buttons. Stiches 907, 908, 909 and 910 further define pockets 901 and 902. It should be noted that due to the softness and elasticity of preferred fabric selections, the size and shape of pockets in either end regions do not need to be strictly rectangular to accommodate any of these items.

In some embodiments, pocket structures identical or analogous to those illustrated in FIG. 9 with reference to end region 102A, may additionally or alternatively be provided at end region 102B. In embodiment featuring pockets at both end regions 102A and 102B, a wearer may be provided with pockets at both ends of section 102 when worn as a scarf separated from section 101.

The multi-component garment described herein may be worn in other manners as well. In some embodiments, the garment may be worn covering a user's head for warmth or religious purposes. For example, if gaiter section 101 is provided with sufficient length, a rear portion of the gaiter may be pulled up and over the back and top of the wearer's head. In other use cases, scarf section 102 may be draped over a wearer's head, and the gaiter section 101 may be put on such that it covers portions of section 102 draping down along sides of the wearer's head. Garment 100 provides a flexible garment that may be worn in numerous different ways, in accordance with a user's preferences.

There are a variety of materials that can be used to manufacture the wearable protective garment as disclosed. Sections 101 and 102 can be made with the same material, but not necessarily so. Since section 101 is generally smaller and often pulled over one's nose, mouth, and face, section 101 may be more prone to dirt and soil; accordingly, synthetic materials, such as polyester spandex anti-microbial moisture-wicking or nylon fabric, may be desirable to minimize weight, durability upon exposure to repeated washing, and quickness to dry. Section 102 is generally larger and often used to provide warmth and coverage, such that natural materials, such as wool or silk, may be desirable in some cases. That said, aesthetic as well as functional concerns in choices of materials may be relevant to certain embodiments but should not be construed as limitations of the present disclosure.

While various embodiments of the present disclosure have been described above, it should be understood that they have been presented by way of example only, and not of limitation. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus the breadth and scope of the present disclosure should not be limited by any of the above-described exemplary embodiments.

Terms and phrases used in this document, and variations thereof, unless otherwise expressly stated, should be construed as open as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A protective garment, comprising:
a first section with a first connection edge removably attached to a corresponding second connection edge of a second section, wherein
the first section is: formed from fabric; tubular in shape; and collapsible to a flat form;
the second section formed of fabric and having a length greater than the first section;
wherein the garment may be utilized in a first configuration in which the first section is detached from the second section and pulled around a user's head for wearing as a gaiter, while the second section may be wrapped around some portion of the user's body; and
wherein the garment may be worn in a second configuration in which the first section and the second section are attached by joining the first connection edge and the second connection edge, and worn around the user's body as a single garment.

2. The protective garment of claim 1, in which the garment is a scarf, and the second section is sized for use as a scarf in both the first configuration and the second configuration.

3. The protective garment of claim 1, in which the garment is a hijab.

4. The protective garment of claim 1, in which the first section further comprises: a pocket configured to receive an air filter therein, the pocket positioned to rest in front of a nose and mouth of the user when the first section is worn in the first configuration.

5. The protective garment of claim 1, in which the second section comprises one or more accessory pockets.

6. The protective garment of claim 4, in which the first section further comprises a cord passing around a circumference of the first section along an edge thereof, and a cord lock to secure the first section in a desired position relative to the user's head while in the first configuration.

7. The protective garment of claim 1, wherein the first connection edge is removably attached to the second connection edge via a plurality of hook and fabric fastener segments, the fastener segments comprising portions of hook material spaced apart from one another along the first and/or second connection edges.

8. The protective garment of claim 1, wherein the first connection edge is removably attached to the second connection edge via a plurality of hook and loop fastener segments spaced apart from one another along the first and second connection edges

9. The protective garment of claim 1, wherein the first connection edge is removably attached to the second connection edge via a zipper mechanism.

10. The protective garment of claim 5, wherein the accessory pockets comprise hook-and-loop or hook-and-fabric closures.

11. The protective garment of claim 5, wherein the accessory pockets comprise zipper closures.

12. The protective garment of claim 1, wherein the first and the second sections are formed from the same fabric material.

13. The protective garment of claim 1, wherein the first section and the second section are each formed from a different fabric material.
